(19) United States
(12) Patent Application Publication
(10) Pub. No.: US 2006/0066781 A1
(43) Pub. Date: Mar. 30, 2006

(54) Color filter panel, and liquid crystal display including color filter panel

(75) Inventors: Bong-Ju Kim, Gyeonggi-do (KR); Yong-Je Jeon, Gyeonggi-do (KR); Sang-Woo Park, Seoul (KR)

Correspondence Address: David W. Heid;MacPHERSON KWOK CHEN & HEID LLP, Suite 226, 1762 Technology Drive, San Jose, CA, 95110, US

(73) Assignee: Samsung Electronics Co., Ltd., Suwon-si (KR)

(21) Appl. No.: 11/234,471

(22) Filed: Sep. 23, 2005

(30) Foreign Application Priority Data
Sep. 24, 2004 (KR) 10-2004-0077514

(51) Int. Cl. G02F 1/1333

(52) U.S. Cl. 349/110

(57) ABSTRACT

A liquid crystal display is provided, which includes: a color filter panel having a first insulating substrate, a reflector having a window and formed on the first insulating substrate, a plurality of color filters formed on the reflector, a light blocking member defining a display area by being formed at the circumference of the first insulating substrate and including a layer disposed on the same layer as the color filters, and a common electrode formed on the color filters; a thin film transistor array panel having a second insulating substrate facing the first insulating substrate, a plurality of gate and data lines formed on the second insulating substrate being insulated from and intersecting with each other, a plurality of thin film transistors connected to the gate and data lines, and a plurality of pixel electrodes connected to the thin film transistors and disposed on the pixel area enclosed by the gate and data lines; and a liquid crystal layer formed between the color filter panel and the thin film transistor array panel.

### BACKGROUND OF THE INVENTION

(a) Field of the Invention

The present invention relates to a color filter panel and a liquid crystal display, and especially to a transflective liquid crystal display including a color filter panel.

(b) Description of Related Art

A liquid crystal display (“LCD”) is one of the most prevalent flat panel displays, and it includes two panels having field-generating electrodes and a liquid crystal layer interposed therebetween. It controls the transmittance of light passing through the liquid crystal layer by adjusting voltages applied to the electrodes to re-arrange liquid crystal molecules in the liquid crystal layer.

One of the most popular of these LCDs has electrodes on the respective panels and a plurality of thin film transistors (“TFTs”) for switching the voltages applied to the electrodes. Generally, the TFTs are provided on one of the two panels.

Such LCDs can be classified into three types, one of which is a transmissive type, which displays images by transmitting light from a light source called a backlight through the liquid crystal layer. A second type is the reflective type, which displays images by reflecting external light such as natural light into the liquid crystal layer using a reflector included in LCD. The third type of LCD is the transflective type, which is capable of operating in both a transmissive mode and a reflective mode.

In the transflective type of LCD, the reflector may be disposed along with color filters, and a portion of the reflector includes a black matrix for preventing light leakage, such that a manufacturing process thereof may be simplified by omitting the black matrix.

However, the reflector, which is disposed at the edge of the LCD, reflects external light into the display area, such that the light leakage is generated at the edge of the LCD.

### SUMMARY OF THE INVENTION

A liquid crystal display is provided, which includes: a color filter panel having a first insulating substrate, a reflector having a window and formed on the first insulating substrate, a plurality of color filters formed on the reflector, a light blocking member defining a display area by being formed at the circumference of the first insulating substrate and including a layer disposed on the same layer as the color filters, and a common electrode formed on the color filters; a thin film transistor array panel having a second insulating substrate facing the first insulating substrate, a plurality of gate and data lines formed on the second insulating substrate and insulated from and intersecting with each other, a plurality of thin film transistors connected to the gate and the data lines, and a plurality of pixel electrodes connected to the thin film transistors and disposed on the pixel area enclosed by the gate and the data lines; and a liquid crystal layer formed between the color filter panel and the thin film transistor array panel.

The liquid crystal display may further include a sealant sealing the liquid crystal layer and formed at the circumference of the display area, and the light blocking member may be disposed interior to the sealant.

The liquid crystal display may further include a sealant sealing the liquid crystal layer and formed at the circumference of the display area, and the sealant may be disposed on the light blocking member.

The color filters may include color filters of red, green, and blue colors, and the layer of the light blocking member may be made of the same layer as one of the color filters of red, green, and blue.

The color filters may include color filters of red and blue.

The portion of the light blocking member may overlap the reflector.

The window may be occupied in the portion of the pixel area.

The reflector may have unevenness.

The color filter panel may further include an insulating layer having unevenness and formed on the first insulating substrate.

The color filter panel may further include an overcoat covering the color filters.

A color filter panel is provided, which includes: an insulating substrate; a reflector having a window and being formed on the insulating substrate; a plurality of color filters formed on the reflector; a light blocking member defining a display area by being formed at the circumference of the insulating substrate and including a layer disposed on the same layer as the color filters; and a common electrode formed on the color filters.

The color filters may include color filters of red, green, and blue colors, and the layer of the light blocking member may be made of the same layer as one of the color filters of red, green, and blue.

The color filters may include color filters of red and blue.

The portion of the light blocking member may overlap the reflector.

The reflector may have unevenness.

The color filter panel may further include an insulating layer having unevenness and formed on the insulating substrate.

The color filter panel may further include an overcoat covering the color filters.

### BRIEF DESCRIPTION OF THE DRAWINGS

The above and other advantages of the present invention will become more apparent in light of the preferred embodiments which are described below in detail with reference to the accompanying drawings, in which:

FIG. 1 is a layout view of a transflective LCD according to an embodiment of the present invention;

FIG. 2 is a sectional view of the LCD taken along the line II-II′;

FIG. 3 shows a layout view of a pixel and a contact portion of the transflective LCD shown in FIG. 1;

FIG. 4 is a sectional view of the LCD shown in FIG. 3, taken along the line IV-IV′; and

FIG. 5 is a sectional view of an LCD according to another embodiment of the present invention, taken along the line II-II′.

### DETAILED DESCRIPTION OF THE PREFERRED EMBODIMENTS

The present invention is described more fully hereinafter with reference to the accompanying drawings, in which preferred embodiments of the invention are shown. This invention may, however, be embodied in many different forms and should not be construed as limited to the embodiments set forth herein. In the drawings, the thickness of layers and regions are exaggerated for clarity. Like numerals refer to like elements throughout. It will be understood that when an element such as a layer, film, region, substrate, or panel is referred to as being “on” another element, it can be directly on the other element or intervening elements may also be present. In contrast, when an element is referred to as being “directly on” another element, there are no intervening elements present.

Now, a color filter panel, a transflective liquid crystal display, and a manufacturing method thereof according to embodiments of the present invention will be described with reference to the drawings.

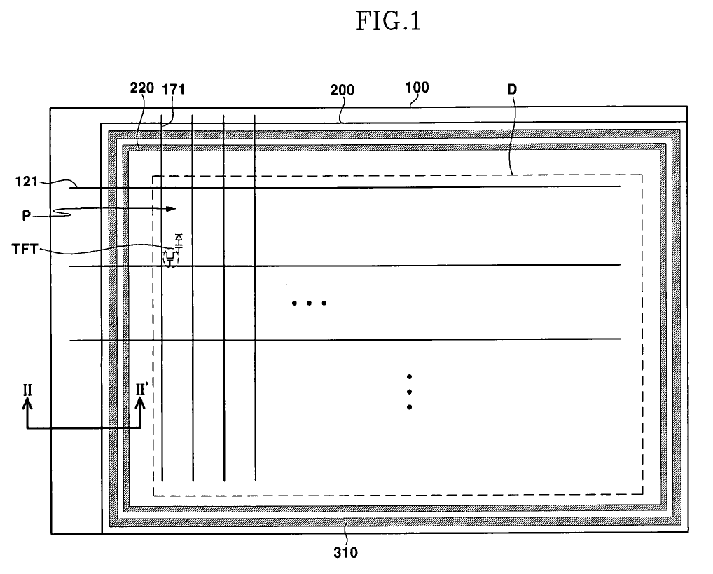

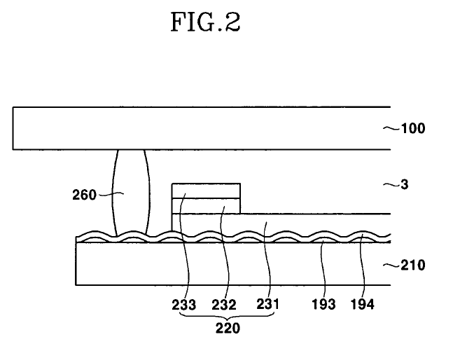

First, a structure of an LCD according to an embodiment of the present invention is described in detail with reference to FIGS. 1 and 2.

FIG. 1 is a layout view of a transflective LCD according to an embodiment of the present invention, and FIG. 2 is a sectional view of the LCD taken along the line II-II′.

As shown in FIGS. 1 and 2, an LCD according to an embodiment of the present invention includes a color filter panel 200 and a thin film transistor array panel 100 facing each other with a liquid crystal layer 3 interposed therebetween. At this time, a reflector 194 is formed on the color filter panel 200, which is disposed under the thin film transistor array panel 100, the image display being displayed on the thin film transistor array panel 100.

A plurality of gate lines 121 and a plurality of data lines 171, which intersect each other to define a plurality of pixel areas P arranged in a matrix, are formed on the thin film transistor array panel 100. In each pixel area P, a TFT connected to the gate and the data lines 121 and 171 and a pixel electrode electrically connected to the TFT are provided. The plurality of pixels P form a display area D.

The end portions of the gate and the data lines 121 and 171 extend outside of the display area D, and they approach each other group by group like a fan and then become parallel again farther away from the display area D. Such an area except for the display area D is referred to as a peripheral area. The end portions of the signal lines 121 and 171 are contact portions to connect to the external circuit.

An insulating layer 193, which has a varying thickness, and a reflector 195 are formed on the color filter panel 200. Because the surface of the insulating layer 193 is not flat, the surface of the reflector 194 is also not flat, thus exhibiting a wave-shaped appearance as viewed in FIG. 2. A light blocking member 220 (indicated by a hatched area) for blocking light leakage to the exterior to the display area D is disposed around the display area D.

The light blocking member 220 includes at least one color filter which represents one of the primary colors such as red, green, and blue colors in the display area D, and has a multi-layered structure including three layers 231, 232, and 233 of color filters. It is preferable that the light blocking member 220 is made by overlapping the color filters of red and green colors, or the color filters of red, green, and blue colors.

In the LCD according to the present invention, because the light blocking member 220 is made of color filters 231, 232, and 233, the light incident on the reflector 194 may be minimized, and the portion of light incident on the reflector 194 transmits through the light blocking member 220 which blocks the light reflected by the reflector 194. Accordingly, the light blocking member 220 may completely block light leakage to the exterior of the display area D.

Because the light blocking member 220 is made of color filters 231, 232, and 233, the additional process for forming the light blocking member 220 may be omitted.

A sealant 260 is formed between the thin film transistor array panel 100 and the color filter panel 200, and the liquid crystal layer 3 between the thin film transistor array panel 100 and the color filter panel 200 is sealed therein by the sealant 260. At this time, the light blocking member 220 is surrounded by the sealant 260, and is more enclosed by the display area D than the sealant 260, as shown in FIGS. 1 and 2.

The LCD according to the embodiment further includes an alignment layer coated on the inside of the two panels 100 and 200, a pair of polarizers provided on outer surfaces of the panels 100 and 200 such that their transmissive axes are crossed, retardation films interposed between the panels and the polarizers, and a backlight unit for providing light for the polarizers, the panels 100 and 200, and the LC layer 3.

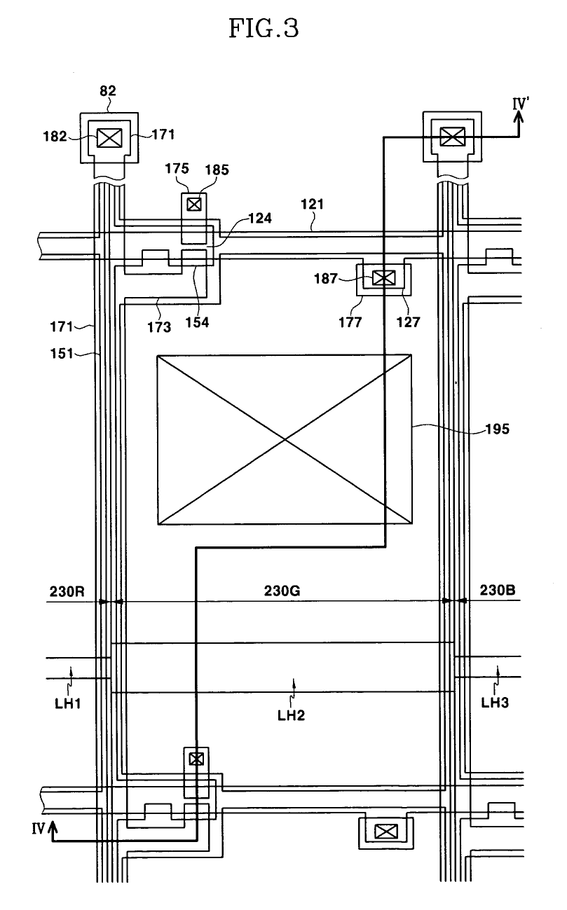

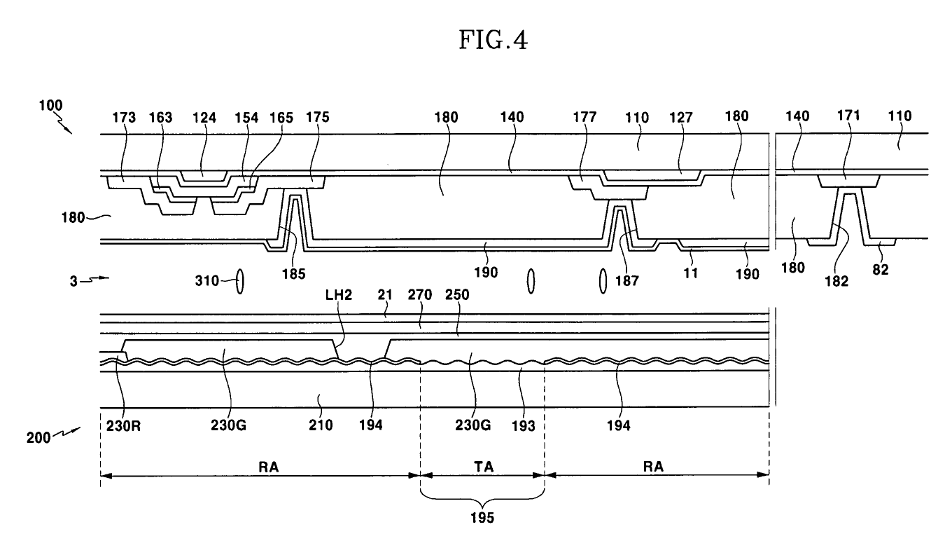

Next, a pixel and a contact portion of an LCD according to an embodiment of the present invention are described in detail with reference to FIGS. 3 and 4.

FIG. 3 shows a layout view of a pixel and a contact portion of the transflective LCD shown in FIG. 1, and FIG. 4 is a sectional view of the LCD shown in FIG. 3 taken along the line IV-IV′.

In a color filter panel 200, as shown in FIGS. 3 and 4, an insulating layer 193 made of an organic material is formed on an insulating substrate 210. The surface of the insulating layer 193 is uneven.

A reflector 194 made of a reflective conductor such as Ag, Al, and their alloys is formed on the insulating layer 193, and the surface of the reflector 194 is also uneven depending on the unevenness of the insulating layer 193. The unevenness of the reflector 195 may maximize reflection.

Reflector 194 is wholly formed within the perimeter of color filter panel 200, and includes a plurality of transmitting windows 195 corresponding to each pixel P (referring to FIG. 1). An area occupied by a transmitting window 195 is referred to as a “transmissive area” TA, while the remaining area of the pixel P is referred to as a “reflective area” RA hereinafter.

A plurality of color filters 230R, 230G, and 230B are formed on the reflector 194 and they are disposed substantially in each pixel. The color filters 230R, 230G, and 230B extend substantially along the longitudinal direction along the pixel row. The color filters 230R, 230G, and 230B each represent one of the primary colors such as red, green, and blue colors, and the boundaries of the color filters 230R, 230G, and 230B are located on signal lines such as a gate and data lines.

A light blocking member 220 (as shown in FIG. 1) for blocking light leakage exterior to the display area D is disposed around the display area D. The light blocking member 220 is made of the same material as the color filters 230R, 230G, and 230B, and includes at least two color filters among the color filters 230R, 230G, and 230B. The deposition order of color filters of the light blocking member 220 may vary depending on a desired formation sequence of the color filters 230R, 230G, and 230B.

The color filters 230R, 230G, and 230B respectively have a plurality of light holes LH1, LH2, and LH3, one of which is shown in FIG. 4. The transflective type of LCD shows non-uniform color reproducibility between the transmissive area TA and the reflective area RA since the number of times the light passes through the color filters is different, which results in deterioration of the display characteristics. That is, the light in the transmissive area passes through the liquid crystal layer 3 and the color filters 230R, 230B, and 230B only once to reach a user's eye, while the light in the reflective area RA passes through the liquid crystal layer and the color filters 230R, 230G, and 230B twice. Therefore, the impressions of the color in the two modes become different, and the light holes LH1, LH2, and LH3 may enhance the color reproduction properties for the two areas TA and RA, thereby improving the display characteristic of the LCD.

Because the visibility of the color filter 230G is higher than that of the color filters 230B and 230R, the light hole LH2 of color filter 230G is larger than the light holes LH1 and LH3. In this embodiment, the light holes LH1, LH2, and LH3 extend along the horizontal longitudinal direction across the pixel to form the light holes LH1, LH2, and LH3, and the areas of the light holes LH1, LH2, and LH3 are varied by controlling the widths of the light holes LH1, LH2, and LH3. The number of light holes LH1, LH2, and LH3 having the same areas may be varied to enhance the color reproduction characteristics.

As shown in FIG. 4, an overcoat 250 for preventing the color filters 230 from being exposed and for providing a flat surface is formed on the color filters 230R, 230G, and 230B and the light blocking member 220.

A common electrode 270 preferably made of a transparent conductive material such as ITO or IZO is formed on the overcoat 250, and an alignment layer 21 is formed on the common electrode 270.

Next, the structure of the thin film transistor array panel 100 facing the color filter panel 200 in the LCD according to the embodiment of the present invention is described in more detail.

The thin film transistor array panel 100 includes an insulating substrate 110. A plurality of gate lines 121 for transmitting gate signals are formed on the insulating substrate 110.

Each gate line 121 extends substantially in a transverse direction, and a plurality of portions of each gate line 121 form a plurality of gate electrodes 124. Each gate line 121 includes a plurality of expansions 127 protruding downward. The gate lines 121 may include an end portion (not shown) having a large area for connection with an external driving circuit.

The gate lines 121 are preferably made of low resistivity material including an Al-containing metal such as Al and an Al alloy (e.g. Al—Nd). The gate lines 121 may have a multi-layered structure including two films having different physical characteristics. One of the two films is preferably made of a low resistivity metal including an Al-containing metal for reducing signal delay or voltage drop in the gate lines 121. The other film is preferably made of a material such as Cr, Mo, a Mo alloy, Ta, or Ti, which has good physical, chemical, and electrical contact characteristics with other materials such as indium tin oxide (ITO) or indium zinc oxide (IZO). Good examples of the combination of the two films are a lower Cr film and an upper Al—Nd alloy film, and a lower Al film and an upper Mo film.

In addition, the lateral sides of the gate lines 121 are inclined relative to a surface of the substrate 110, and a gate insulating layer 140 preferably made of silicon nitride (SiNx) or the like covers the gate lines 121.

A plurality of semiconductor stripes 151 preferably made of hydrogenated amorphous silicon (abbreviated to “a-Si”) or polysilicon are formed on the gate insulating layer 140. Each semiconductor stripe 151 extends substantially in the longitudinal direction and has a plurality of projections 154 branched out toward the gate electrodes 124. The semiconductor stripes 151 become wide near the gate lines 121 such that the semiconductor stripes 151 cover large areas of the gate lines 121.

A plurality of ohmic contact stripes and islands 161 and 165 preferably made of silicide or n+ hydrogenated a-Si heavily doped with an N-type impurity such as phosphorous are formed on the semiconductor stripes 151. Each ohmic contact stripe 161 has a plurality of projections 163, and the projections 163 and the ohmic contact islands 165 are located in pairs on the projections 154 of the semiconductor stripes 151.

The lateral sides of the semiconductor 151 and ohmic contact stripes and islands 161 and 165 are inclined relative to a surface of the substrate 110.

A plurality of data lines 171, a plurality of drain electrodes 175, and a plurality of storage capacitor conductors 177 are formed on the ohmic contacts 161 and 165 and the gate insulating layer 140.

The data lines 171 for transmitting data voltages extend substantially in the longitudinal direction and intersect the gate lines 121. A plurality of branches of each data line 171, which project toward the drain electrodes 175, form a plurality of source electrodes 173. Each pair of the source electrodes 173 and the drain electrodes 175 are separated from each other and are opposite each other with respect to a gate electrode 124.

A gate electrode 124, a source electrode 173, and a drain electrode 175 along with the projection 154 of a semiconductor stripe 151 form a TFT having a channel formed in the projection 154 disposed between the source electrode 173 and the drain electrode 175.

The storage capacitor conductors 177 overlap the expansions 127 of the gate lines 121.

The data lines 171, the drain electrode 175, and the storage conductors 177 are preferably made of a refractory metal including Cr, Mo, Ti, Ta, or alloys thereof. They may have a multi-layered structure preferably including a low resistivity film and a good contact film. A good example of the multi-layered structure includes a Mo lower film, an Al middle film, and a Mo upper film as well as the above-described combinations of a Cr lower film and an Al—Nd upper film and an Al lower film and a Mo upper film.

The ohmic contacts 161 and 165 are interposed only between the underlying semiconductor stripes 151 and the overlying data lines 171 and the overlying drain electrodes 175 thereon, and they reduce the contact resistance therebetween. The semiconductor stripes 151 include a plurality of exposed portions, which are not covered with the data lines 171 and the drain electrodes 175, such as portions located between the source electrodes 173 and the drain electrodes 175. Although the semiconductor stripes 151 are narrower than the data lines 171 at most places, the width of the semiconductor stripes 151 becomes large near the gate lines as described above, to enhance the insulation between the gate lines 121 and the data lines 171.

A passivation layer 180 is formed on the data lines 171, the drain electrodes 175, the storage conductors 177, and the exposed portions of the semiconductor stripes 151. The passivation layer 180 is preferably made of a photosensitive organic material having a good flatness characteristic.

The passivation layer 180 may further include an insulating layer made of an inorganic material such as silicon nitride and silicon oxide to prevent the semiconductor 151 between the drain electrode 175 and the source electrode 173 from contacting the organic layer.

The passivation layer 180 is etched to provide a plurality of contact holes 185, 187, and 182 exposing the drain electrodes 175, the storage conductors 177, and end portions of the data lines 171, respectively. The end portions have larger areas than those of the gate lines 121 and the data lines 171.

A plurality of pixel electrodes 190, and a plurality of contact assistants 82, which are preferably made of at least one of transparent conductor such as ITO or IZO, are formed on the passivation layer 180.

The pixel electrodes 190 are physically and electrically connected to the drain electrodes 175 through the contact holes 185 and to the storage capacitor conductors 177 through the contact holes 187 such that the pixel electrodes 190 receive the data voltages from the drain electrodes 175 and transmit the received data voltages to the storage capacitor conductors 177.

Referring to FIG. 4, the pixel electrodes 190 which are supplied with the data voltages generate electric fields in cooperation with the common electrode 270 which is located on the color panel 200, and this determines the orientation of liquid crystal molecules 310 in a liquid crystal layer 3.

As described above, a pixel electrode 190 and a common electrode 70 form a liquid crystal capacitor, which stores applied voltages after turn-off of the TFT. An additional capacitor called a “storage capacitor,” which is connected in parallel to the liquid crystal capacitor, is provided for enhancing the voltage storing capacity.

The storage capacitors are implemented by overlapping the pixel electrodes 190 with the gate lines 121 adjacent thereto (called “previous gate lines”). The capacitances of the storage capacitors, i.e., the storage capacitances, are increased by providing the expansions 127 at the gate lines 121 for increasing overlapping areas and by providing the storage capacitor conductors 177, which are connected to the pixel electrodes 190 and overlap the expansions 127, under the pixel electrodes 190 for decreasing the distance between the terminals.

When forming the passivation layer 180 which has a low dielectric ratio, the pixel electrodes 190 overlap the gate lines 121 and the data lines 171 to increase the aperture ratio, but this is optional.

The contact assistants 82 are connected to the end portions of the data lines 171 through the contact holes 182. The contact assistants 82 protect the end portions 179 and complement the adhesion of the end portions 179 and external devices.

An alignment layer 11 is formed on the pixel electrode 190.

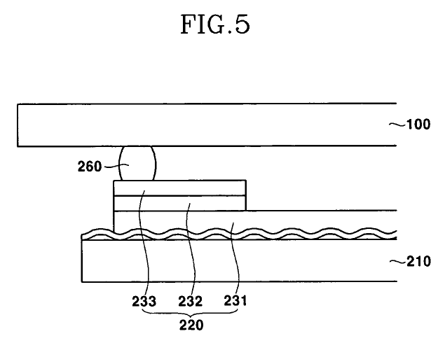

Now, an LCD according to another embodiment of the present invention will be described with reference of FIG. 5.

Another embodiment of the present invention is illustrated in FIG. 5 which is a sectional view of an LCD according to another embodiment of the present invention taken along the line II-II′.

As shown in FIG. 5, a sealant 260 is disposed on a light blocking member 220.

In the LCD according to the present invention, the light blocking member 220 may completely block light leakage exterior to the display area by forming the light blocking member using color filters without the additional process, thereby enhancing the characteristics of the LCD.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A liquid crystal display comprising:
a color filter panel comprising:
a first insulating substrate;
a reflector including a window formed on the first insulating substrate;
a plurality of color filters formed on the reflector;
a light blocking member defining a display area and being formed at a circumference of the first insulating substrate, wherein the light blocking member is constructed using a portion of a layer of one or more of the color filters;
and a common electrode formed on the color filters;
a thin film transistor array panel comprising:
a second insulating substrate;
a plurality of gate and data lines formed on the second insulating substrate and insulated from and intersecting each other;
a plurality of thin film transistors connected to the gate and the data lines;
and a plurality of pixel electrodes connected to the thin film transistors and disposed on the pixel area enclosed by the gate and the data lines; and,
a liquid crystal layer positioned between the color filter panel and the thin film transistor array panel.

2. The liquid crystal display of claim 1, further comprising:
a sealant interposed between the color filter panel and the thin film transistor array panel, the sealant being positioned at the circumference of the display area,
wherein the light blocking member is disposed interior to the sealant.

3. The liquid crystal display of claim 1, further comprising:
a sealant interposed between the color filter panel and the thin film transistor array panel, the sealant being positioned at the circumference of the display area,
the sealant being disposed on the light blocking member.

4. The liquid crystal display of claim 1, wherein the color filters include color filters of red and blue colors, and a layer of the light blocking member is made of the same layer as one of the color filters of red and blue.

5. The liquid crystal display of claim 4, wherein the color filters further include a green color filter.

6. The liquid crystal display of claim 1, wherein a portion of the light blocking member overlaps the reflector.

7. The liquid crystal display of claim 1, wherein the window is occupied in the portion of the pixel area.

8. The liquid crystal display of claim 1, wherein a surface of the reflector is wave-shaped.

9. The liquid crystal display of claim 4, wherein the color filter panel further includes an insulating layer having a varying thickness formed on the first insulating substrate.

10. The liquid crystal display of claim 4, wherein the color filter panel further includes an overcoat covering the color filters.

11. A color filter panel comprising:
an insulating substrate;
a reflector having a window and formed on the insulating substrate;
a plurality of color filters formed on the reflector;
a light blocking member defining a display area and being formed at a circumference of the insulating substrate, wherein the light blocking member is constructed using a portion of a layer of one or more of the color filters;
a common electrode formed on the color filters.

12. The color filter panel of claim 11, wherein the color filters include color filters of red and blue colors, and the layer of the light blocking member is made of the same layer as one of the color filters of red and blue.

13. The color filter panel of claim 12, wherein the color filters further include a green color filter.

14. The color filter panel of claim 11, wherein a portion of the light blocking member overlaps the reflector.

15. The color filter panel of claim 11, wherein a surface of the reflector is wave-shaped.

16. The color filter panel of claim 11, further comprising:
an insulating layer having a varying thickness formed on the insulating substrate.

17. The color filter panel of claim 11, further comprising:
an overcoat covering the color filters.
